(19) United States
(12) Patent Application Publication
(10) Pub. No.: US 2014/0151155 A1
(43) Pub. Date: Jun. 5, 2014

(54) FAILSAFE RETRACTABLE LANYARD MECHANISM

(71) Applicant: Reliance Industries, LLC, Wheat Ridge, CO (US)

(72) Inventor: Gary E. Choate, Lakewood, CO (US)

(73) Assignee: Reliance Industries, LLC, Wheat Ridge, CO (US)

(21) Appl. No.: 14/094,422

(22) Filed: Dec. 2, 2013

Related U.S. Application Data
(60) Provisional application No. 61/738,981, filed on Dec. 18, 2012.
(60) Provisional application No. 61/732,400, filed on Dec. 2, 2012.

(51) Int. Cl. A62B 1/10

(52) U.S. Cl. CPC A62B 1/10
USPC 182/239

(57) ABSTRACT

A failsafe mechanism for a lanyard comprising a backing plate, a pawl rotatably mounted on the backing plate and having an engagement portion and a cam portion, and a sperrad mounted on the backing plate in proximity to the pawl. The sperrad has engagement and cam portions and rotates relative to the pawl to define an engagement zone where the pawl and sperrad engage. The sperrad and pawl engagement portions engage when the pawl engagement portion is within the engagement zone and the sperrad engagement portion rotates into engagement. The pawl is configured to rotate only between a first arc in which the engagement portion remains at least partially within the engagement zone and a second arc in which the pawl halts the sperrad rotation should the pawl be held within the second arc.

### CROSS REFERENCE TO RELATED APPLICATIONS

This application derives and claims priority from U.S. provisional application 61/738,981 filed Dec. 18, 2012, and U.S. provisional application 61/732,400 filed Dec. 2, 2012, both applications which are incorporated herein by reference.

### STATEMENT REGARDING FEDERALLY SPONSORED RESEARCH OR DEVELOPMENT

Not applicable.

### BACKGROUND OF THE INVENTION

This invention relates generally to retractable lanyards, and more particularly to a mechanism for a retractable lanyard that is configured to ensure that the lanyard will not unwind should the lanyard components become fouled or frozen in place.

Lanyards are safety devices that are designed to allow an individual to operate safely at what would otherwise be dangerous or deadly heights without risk of harm. Each lanyard comprises a cable, known as a lifeline, that is held in the lanyard on a reel. When the lifeline is pulled from the lanyard at a relatively slow rate, such as when the user is moving about but not falling, the lanyard allows the reel unwind and the lifeline to extend from the lanyard. However, when the lifeline is pulled from the lanyard at a very rapid rate such as when a user is falling, a clutch or shock absorber or other similar mechanism in or associated with the lanyard will automatically engage and slow and/or stop the reel from unwinding. This halts the individual's fall after only a very brief interval.

One such lanyard has an internal clutch system in which a pawl plate has a stack of friction discs on each side of mounted with Bellville springs that apply up to approximately 3000 pounds per square inch of compressive force to each side of the plate. This creates normal forces on friction pads that softly stop the release of the lifeline.

In many circumstances, lanyards are used in conditions that can result in the lanyard mechanism becoming fouled with debris or ice such that the components do not operate properly and freeze in place. This results in a very dangerous situation in that the lanyard components may become frozen in a release position that allows the lifeline to freely discharge from the lanyard without stopping. Should a user be attached to a lanyard in this condition and fall, relying upon the lanyard to stop the fall, the lifeline will instead continue to discharge to its full length and can thereby cause serious injury or even death to the user.

It would therefore be desirable to have a lanyard that comprises a mechanism that allows for the proper operation of the lanyard but that is configured to operate to stop a fall even if the mechanism is subjected to conditions that foul or freeze the components.

As will become evident in this disclosure, the present invention provides benefits over the existing art.

### BRIEF DESCRIPTION OF THE DRAWINGS

The illustrative embodiments of the present invention are shown in the following drawings which form a part of the specification:

FIG. 1 is a plan view of a traditional lanyard pawl and sperrad mechanism positioned on a backing plate and oriented at maximum rotational travel of the pawl along its cam interface with the sperrad;

FIG. 2 is another plan view of the traditional lanyard pawl and sperrad mechanism of FIG. 1 oriented at minimum rotational travel of the pawl along its cam interface with the sperrad;

FIG. 3 is a plan view of a lanyard pawl and sperrad mechanism incorporating one embodiment of the present invention positioned on a backing plate and oriented at maximum rotational travel of the pawl along its cam interface with the sperrad;

FIG. 4 is another plan view of the lanyard pawl and sperrad mechanism of FIG. 3 oriented at minimum rotational travel of the pawl along its cam interface with the sperrad;

FIG. 5 is a perspective view of the lanyard pawl and sperrad mechanism of FIG. 1 positioned on a backing plate and oriented at maximum rotational travel of the pawl along its cam interface with the sperrad;

FIG. 6 is a perspective view of the lanyard pawl and sperrad mechanism of FIG. 3 positioned on a backing plate and oriented at maximum rotational travel of the pawl along its cam interface with the sperrad;

FIG. 7 is a plan view of the lanyard pawl components of FIG. 3 positioned on a backing plate and attached to springs;

FIG. 8 is a plan view of the lanyard sperrad of FIG. 3;

FIG. 9 is cross-sectional view A-A of the lanyard sperrad of FIG. 8;

FIG. 10 is cross-sectional view B-B of the lanyard sperrad of FIG. 8;

FIG. 11 is a plan view of the obverse of the lanyard sperrad of FIG. 3;

FIG. 12 is a plan view of a lanyard pawl and sperrad mechanism incorporating another embodiment of the present invention positioned on a backing plate and oriented at maximum rotational travel of the pawl along its cam interface with the sperrad;

FIG. 13 is another plan view of the lanyard pawl and sperrad mechanism of FIG. 12 oriented near the minimum rotational travel of the pawl along its cam interface with the sperrad;

Corresponding reference characters indicate corresponding parts throughout the several views of the drawings.

### DETAILED DESCRIPTION

While the invention will be described and disclosed here in connection with certain preferred embodiments, the description is not intended to limit the invention to the specific embodiments shown and described here, but rather the invention is intended to cover all alternative embodiments and modifications that fall within the spirit and scope of the invention as defined by the claims included herein as well as any equivalents of the disclosed and claimed invention.

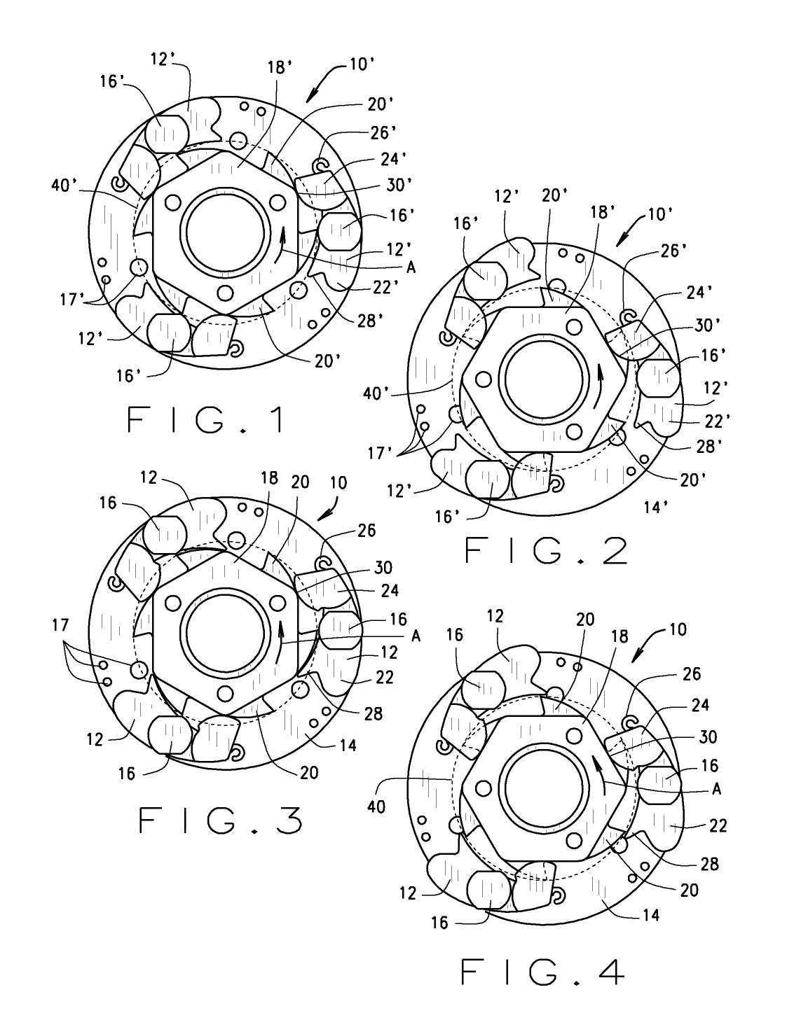

In referring to the drawings, for comparative purposes a traditional internal clutch lanyard pawl and sperrad mechanism lacking the present failsafe configurations of the present invention is shown generally at 10′ in FIGS. 1-2 and 5. As can be seen, the lanyard mechanism 10′ includes three pawls 12′ rotatably mounted on a circular pawl backing plate 14′ by capped pawl pins 16′. The backing plate 14′ has various mounting holes 17′ for attachment to other lanyard components. The pawls 12′ are mounted equidistant from one another along a radius near the outer edge of the backing plate 14′. A substantially flat and hexagonal sperrad 18′ is rotatably mounted in the center of the backing plate 14′, where the sperrad 18′ is able to rotate about its central axis X′ (see FIG. 5) in a counterclockwise rotational direction A. The sperrad 18′ has a set of six teeth 20′ that extend at uniform intervals outward from each side of the sperrad 18′ near the hexagonal peaks of the sperrad. Each of the teeth 20′ are of uniform shape and size and are all uniformly oriented in the same rotational direction, similar to a circular saw blade.

Each of the pawls 12′ has an engagement end 22′ and an opposing cam end 24′. A hook 26′ is positioned on the cam end 24′ for attachment to a tension spring that is attached to the backing plate 14′ (not shown). The engagement end 22′ has an engagement tip 28′ that extends downward towards the sperrad 18′ and is oriented to face and at times interact with the teeth 20′ as they rotate in the direction A. Similarly, the cam end 24′ has a cam face 30′ that extends downward towards the sperrad 18′ and is oriented to face and interact with the hexagonal perimeter of the sperrad 18′ as it rotates about its central axis in the backing plate 14′.

In referring to FIG. 5 it can be seen that the pawls 12′ and the sperrad 18′ share complementary layered dimensions. That is, the teeth 20′ and the engagement tips 28′ of each pawl 12′ are all positioned at a planar level or layer closest to the backing plate 14′, while the cam faces 30′ of each pawl 12′ are all positioned at a planar level or layer distanced from the backing plate 14′. As can be appreciated, this configuration allows the teeth 20 engage the engagement tips 28′ while at the same time preventing the teeth 20′ from engaging the cam faces 30′ as the sperrad 18′ rotates about its central axis within the backing plate 14′.

As can be appreciated, the pawl 12′, the sperrad 18′ and the backing plate 14′ are configured such that when the sperrad 18′ rotates about its axis X′ within the backing plate 14′, the cam ends 30′ of each pawl 12′ will ride along the hexagonal perimeter of the sperrad 18′. The movement of the cam ends 30′ on the sperrad 18′ in turn define the opposing movement of the engagement ends 28′ as the pawls 12′ rotate about the pins 16′. Hence, when the cam ends 30′ engage the corners of the hexagonal perimeter of the sperrad 18′, the engagement ends 22′ of the pawls 12′ reach their minimum engagement position relative to the teeth 20′. Contrastingly, when the cam ends 30′ engage the center of the sides of the hexagonal perimeter of the sperrad 18′, the engagement ends 22′ of the pawls 12′ reach their maximum engagement position relative to the teeth 20′. The area in which the cam ends 30′ engage the sperrad 18′ is known as the engagement zone, which has a maximum radius or engagement zone limit when the pawls 12′ reach their maximum engagement positions, as depicted by the broken line at 40′.

Under normal operating conditions, and in particular when the pawl and sperrad mechanism is clean, the pawl 12′ can rotate sufficiently for the engagement tip 28′ to travel into the engagement zone below the engagement zone limit 40′ to engage the teeth 20′. Unfortunately, it has been learned that when debris, such as grit or ice, lodges in the components having a mechanism such as in FIGS. 1, 2 and 5, the pawl 12′ can become immobile at or near the position depicted in FIG. 1. When this happens, the engagement ends 28′ cannot engage the teeth 20′ to stop the rotation of the sperrad 18′, which is then free to spin about its axis X′ and fully release the entire lifeline.

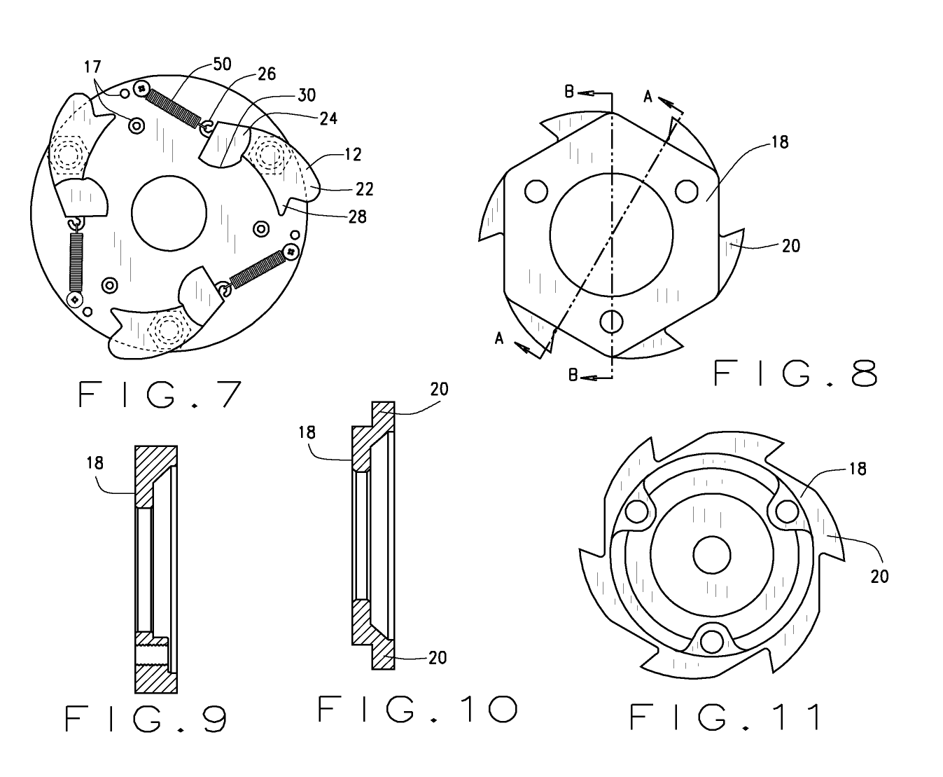

In contrast to a traditional internal clutch lanyard pawl and sperrad mechanism such as 10′, an embodiment of the failsafe retractable lanyard mechanism is shown generally at 10 in FIGS. 3-4 and 6, where the present invention is depicted by way of example. As can be seen, the novel failsafe lanyard mechanism 10 includes three pawls 12 rotatably mounted on a circular pawl backing plate 14 by capped pawl pins 16 (see also FIG. 7). The backing plate 14 has various mounting holes 17 for attachment to other lanyard components. The pawls 12 are mounted equidistant from one another along a radius near the outer edge of the backing plate 14. A substantially flat and hexagonal sperrad 18 (see FIGS. 8-11) is rotatably mounted in the center of the backing plate 14, where the sperrad 18 is able to rotate about its central axis X (see FIG. 6) in a counterclockwise rotational direction A. The sperrad 18 has a set of six teeth 20 that extend at uniform intervals outward from each side of the sperrad 18 near the hexagonal peaks of the sperrad. Each of the teeth 20 are of uniform shape and size and are all uniformly oriented in the same rotational direction, similar to a circular saw blade.

Each of the pawls 12 has an engagement end 22 and an opposing cam end 24. A hook 26 is positioned on the cam end 24 for attachment to one end of a tension spring 50 that is in turn attached at its other end to the backing plate 14 (see FIG. 7). The spring 50 urges the pawl 12 to rotate about the pawl pin 16 such that the pawl engagement end 30 maintains contact with the hexagonal perimeter of the sperrad 18. The engagement end 22 has an engagement tip 28 that extends downward towards the sperrad 18 and is oriented to face and at times interact with the teeth 20 as they rotate in the direction A. However, in contrast to the engagement ends 28′ of the traditional mechanism 10′, the engagement ends 28 have extended downwardly directed tips. Similarly, like the cam ends 24′ of the traditional mechanism 10′, the cam ends 24 have each have a cam face 30 that extends downward towards the sperrad 18 that is oriented to face and interact with the hexagonal perimeter of the sperrad 18 as it rotates about its central axis in the backing plate 14. However, in contrast to the cam ends 24′ of the traditional mechanism 10′, the cam faces 30 of each end 24 are also modified to extend downward further than the traditional cam faces 30′.

In referring to FIG. 6 it can be seen that the pawls 12 and the sperrad 18 share complementary layered dimensions. That is, the teeth 20 and the engagement tips 28 of each pawl 12 are all positioned at a planar level or layer closest to the backing plate 14, while the cam faces 30 of each pawl 12 are all positioned at a planar level or layer distanced from the backing plate 14. As can be appreciated, this configuration allows the teeth 20 engage the engagement tips 28 while at the same time preventing the teeth 20 from engaging the cam faces 30 as the sperrad 18 rotates about its central axis within the backing plate 14.

As in the traditional mechanism 10′, for the novel mechanism 10 the pawl 12, the sperrad 18 and the backing plate 14 are configured such that when the sperrad 18 rotates about its axis X within the backing plate 14, the cam ends 30 of each pawl 12 will ride along the hexagonal perimeter of the sperrad 18. The movement of the cam ends 30 on the sperrad 18 in turn define the opposing movement of the engagement ends 28 as the pawls 12 rotate about the pins 16. Hence, when the cam ends 30 engage the corners of the hexagonal perimeter of the sperrad 18, the engagement ends 22 of the pawls 12 reach their minimum engagement position relative to the teeth 20. Contrastingly, when the cam ends 30 engage the center of the sides of the hexagonal perimeter of the sperrad 18, the engagement ends 22 of the pawls 12 reach their maximum engagement position relative to the teeth 20. The maximum radius or engagement zone limit of the novel failsafe lanyard mechanism for the configuration 10 is depicted by the broken line at 40.

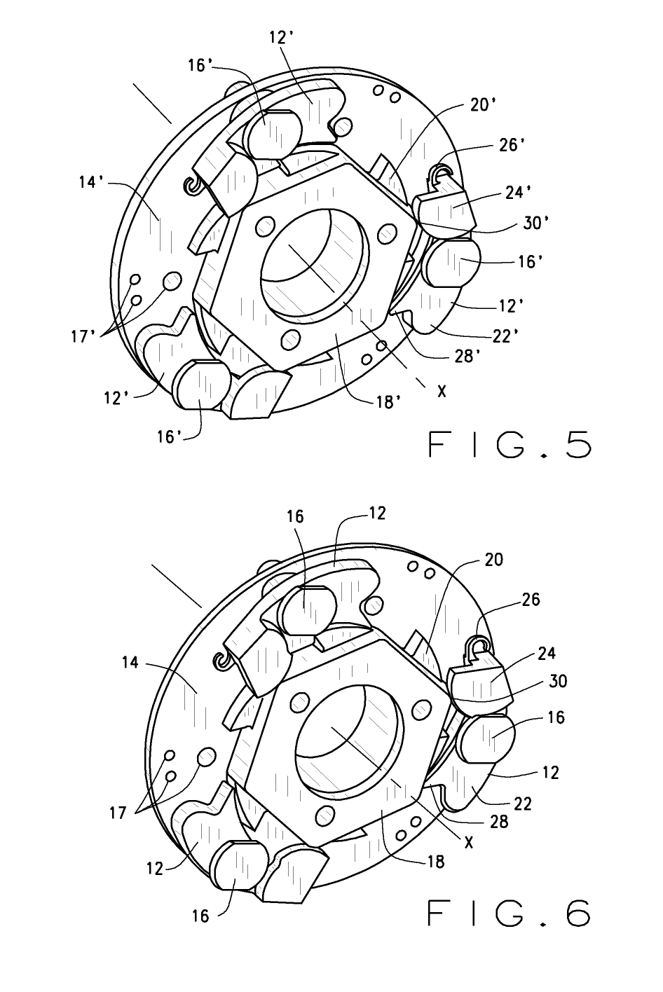

As can be seen, when operating the mechanism 10, the pawl 12 can rotate sufficiently for the engagement tip 28 to travel into the engagement zone below the engagement zone limit 40 to engage the teeth 20. However, unlike the traditional mechanism 10′, because of the extension to the cam faces 30 as compared to the cam faces 30′, and the extended engagement tips 28 as compared to the engagement tips 28′, the pawls 12 cannot rest or become locked in a position, such as the mechanism 10′ seen in FIG. 1. Rather, the even if the pawls 12 were to lock in the position as shown in FIG. 4 with the engagement tips 28 outside the engagement zone, the contact between the cam end 24 and the sperrad 18 will either force the sperrad 18 to cease rotation or alternatively the rotation of the sperrad 18 in the direction A will force the sperrad 18 to rotate the engagement tips 28 into the engagement zone where they will engage the teeth 20. In either case, there is no position or dead zone for the pawl 12 to rest at which the pawl 12 will allow the sperrad 18 to rotate freely without stopping the rotation of the sperrad 18.

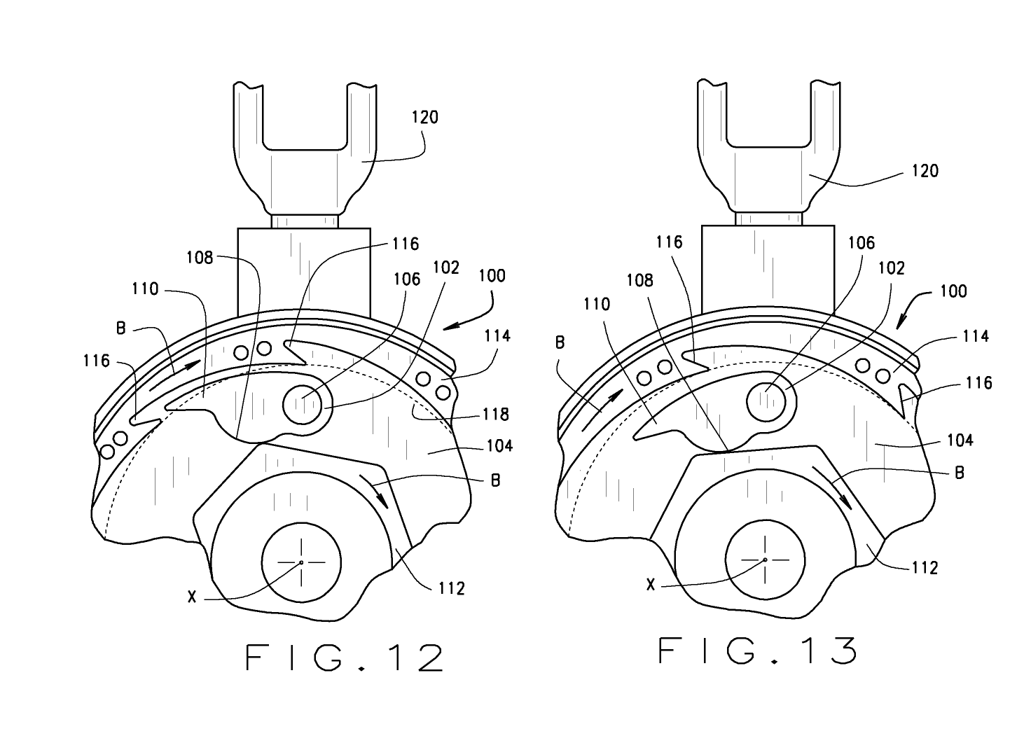

Referring now to FIGS. 12 and 13, an alternate embodiment of the failsafe retractable lanyard mechanism is disclosed and shown generally at 100. As can be seen, this embodiment of the novel failsafe lanyard mechanism 100 includes a set of cantilevered pawls 102, though only one is shown by way of example in FIGS. 12 and 13. Each of the pawls 102 is fixedly mounted at one end to a frame (not shown) by pawl pins 106. The pawls 102 are mounted equidistant from one another along a radius near the outer edge of a circular backing plate 104. Each of the pawls 102 has an inward facing rounded cam surface 108 and an elongated engagement tip 110 pointed away from the pawl pin 106.

A substantially flat and hexagonal sperrad cam 112 is rotatably mounted in the center of the backing plate 104, where the sperrad cam 112 is able to rotate about its central axis X, perpendicular to the plane of the mechanism 100 as shown in FIGS. 12 and 13. A set of springs (not shown) apply constant force to each of the pawls 102 to urge the pawls 102 to rotate about the pawl pins 106 toward, and maintain contact with, the hexagonal perimeter of the sperrad cam 112.

A generally flat rotatable sperrad ring 114 is generally coplanar with and encircles the pawls 102. The sperrad ring 114 has a set of tooth-shaped and angled grooves 116 that face generally inward toward the pawl engagement tips 110. The grooves 116 are positioned at regular and uniform intervals along the inner edge of the sperrad ring 114. Each of the grooves 116 are all uniformly oriented in the same rotational direction and of uniform shape and size to complement and releasably receive the pawl engagement tips 110. The sperrad cam 112 and the sperrad ring 114 are both rigidly mounted to the backing plate 104 and slidingly mounted to a drum housing (not shown), and accordingly rotate in unison about the axis X in a clockwise direction B. In this way, when the sperrad cam 112 and the sperrad ring 114 rotate in the direction B, the pawl cam surface 108 rides along the hexagonal perimeter of the sperrad cam 112 and the pawl 102 rotates up and down about the pawl pin 106 in response. The mechanism 100 is attached to a rotatable clasp 120 for securing or clasping of the mechanism 100 to another object.

As can be seen in FIGS. 12 and 13, the minimum radius or engagement zone limit of the novel failsafe lanyard mechanism for the configuration 100 is depicted by the broken line at 118. For the embodiment 100, the position of the pawl pin 106 relative to the sperrad cam 112 and the sperrad ring 114, the distance between the pawl 102 and the sperrad cam 112, the distance between the pawl 102 and the sperrad ring 112, the distance between the engagement tip 110 and the pawl pin 106, the thickness of the pawl 102, and the shape of the pawl cam surface 108 are all configured such that engagement tips 110 do not normally engage the sperrad ring 114. Rather, when the cam surfaces 108 engage the corners of the hexagonal perimeter of the sperrad cam 112, the engagement tips 110 of the pawls 102 reach their maximum engagement position relative to the grooves 116. Contrastingly, when the cam surfaces 108 engage the center of the sides of the hexagonal perimeter of the sperrad cam 112, the engagement tips 110 of the pawls 102 reach their minimum engagement position relative to the grooves 116.

Accordingly, and as can be appreciated, when operating the mechanism 100, the pawl 102 can rotate sufficiently for the engagement tips 110 to travel into the engagement zone above the engagement zone minimum limit 118 to engage the grooves 116. However, because the cam surfaces 108 force the pawls 102 to rotate about the pawl pins 106 to such an extent that engagement tips 110 engage the grooves 116 as the pawl cam surfaces 108 ride atop the corners of the hexagonal perimeter of the sperrad cam 112, the pawls 102 cannot rest or become locked in a position in which the pawls 102 will not engage the grooves 116. Rather, the even if the pawls 102 were to lock in the position as shown in FIG. 13 with the engagement tips 28 outside the grooves 116, the contact between the pawl cam surfaces 108 and the sperrad cam 112 will either force the sperrad cam 112 to cease rotation or alternatively the rotation of the sperrad cam 108 in the direction B will force the sperrad cam 108 to rotate the engagement tips 110 into the engagement zone where they will engage the teeth 116. In either case, there is no position or dead zone for the pawl 102 to rest at which the pawl 102 will allow the sperrad 108 to rotate freely without stopping the rotation of the sperrad 108.

While I have described in the detailed description several configurations that may be encompassed within the disclosed embodiments of this invention, numerous other alternative configurations, that would now be apparent to one of ordinary skill in the art, may be designed and constructed within the bounds of my invention as set forth in the claims. Moreover, the above-described novel mechanisms of the present invention, shown by way of example at 10 and 100, can be arranged in a number of other and related varieties of configurations without departing from or expanding beyond the scope of my invention as set forth in the claims.

For example, the sperrad 18 need not be hexagonal, but may be a variety of other shapes, such as for example octagonal or heptagonal, as long as the sperrad 18 is configured to interact properly with the other components of the mechanism 10 to achieve the novel results as described herein. Similarly, by way of example, the teeth 20 need not be shaped as shown, but may be any variety of differing shapes so long as they properly interact with the engagement tips 28. Still further, the mechanism 10 need not have exactly three pawls 12, but may have as few as a single pawl 12 or many more than three, again, so long as the pawls 12 enable the mechanism 10 to operate as described herein.

Also, the sperrad 18 is not restricted to having a set of exactly six teeth 20 at uniform intervals, nor that the teeth 20 must all be of uniform shape and size and uniformly oriented in the same rotational direction. Rather, there may be more or less than six teeth 20 on the sperrad 18, and the teeth 20 may be of varying sizes and shapes, so long as they properly operate as part of the failsafe mechanism as outlined in this disclosure.

Additional variations or modifications to the configuration of the novel mechanism of the present invention, shown by way of example at 10 and 100, may occur to those skilled in the art upon reviewing the subject matter of this invention. Such variations, if within the spirit of this disclosure, are intended to be encompassed within the scope of this invention. The description of the embodiments as set forth herein, and as shown in the drawings, is provided for illustrative purposes only and, unless otherwise expressly set forth, is not intended to limit the scope of the claims, which set forth the metes and bounds of my invention.

What is claimed is:

1. A failsafe mechanism for a lanyard comprising:
a. a base;
b. a movable pawl positioned on the base and having an engagement portion; and
c. a movable sperrad positioned in proximity to the pawl, the pawl and sperrad defining an engagement zone there between, the pawl configured to move its engagement portion into and out of the engagement zone, the sperrad configured to releasably engage the pawl engagement portion when the engagement portion is within the engagement zone;
wherein the pawl is configured to move only between a first position at which the engagement portion is oriented at least in part within the engagement zone and a second position at which the pawl halts the movement of the sperrad should the pawl be refrained from movement.

2. The mechanism of claim 1, wherein the pawl comprises a cam portion and the sperrad comprises a cam surface, the pawl cam portion configured to engage the sperrad cam surface.

3. The mechanism of claim 2, wherein the sperrad rotates relative to the pawl.

4. The mechanism of claim 3, wherein the rotation of the sperrad moving the cam surface relative to the pawl to urge the pawl engagement portion into the engagement zone.

5. The mechanism of claim 2, further comprising a biasing member, the biasing member urging the pawl cam portion into engagement with the sperrad cam surface.

6. The mechanism of claim 3, further comprising a plurality of pawls positioned about the sperrad and mounted on a backing plate and having an engagement portion and a cam portion, each pawl being configured to rotate only between a first arc in which the engagement portion remains at least in part within the engagement zone and a second arc in which the pawl halts the rotation of the sperrad should the pawl be refrained from rotating out of the second arc.

7. The mechanism of claim 1, wherein the mechanism comprises a sperrad cam and a sperrad ring, the sperrad cam rotating relative to the pawl, the sperrad ring encircling and rotating about the pawl and sperrad cam, the engagement zone oriented between the pawl and the sperrad ring, the sperrad cam moving the pawl to urge the pawl engagement portion into the engagement zone.

8. The mechanism of claim 1, further comprising a pawl pin operatively associated with the pawl such that the pawl rotates about the pawl pin relative to the sperrad.

9. The mechanism of claim 1, wherein the sperrad comprises a tooth configured to releasably engage the engagement portion of the pawl.

10. The mechanism of claim 1, wherein the sperrad comprises a groove configured to releasably engage the engagement portion of the pawl.

11. A failsafe mechanism for a lanyard comprising:
a. a backing plate;
b. a pawl rotatably mounted on the backing plate and having an engagement portion and a cam portion; and
c. a sperrad mounted on the backing plate in proximity to the pawl, the sperrad having an engage engagement portion and a cam portion, the sperrad configured to rotate relative to the pawl to define an engagement zone there between in which the pawl and sperrad engage one another, the sperrad further configured to releasably engage the sperrad engagement portion with the pawl engagement portion when the pawl engagement portion is within the engagement zone and the sperrad rotates the sperrad engagement portion into engagement with the pawl engagement portion;
wherein the pawl is configured to rotate only between a first arc in which the engagement portion remains at least in part within the engagement zone and a second arc in which the pawl halts the rotation of the sperrad should the pawl be refrained from rotating out of the second arc.

12. The mechanism of claim 11, further comprising a pawl pin, the pawl mounted to and rotating about the pawl pin.

13. The mechanism of claim 12, wherein the pawl pin is mounted between the pawl engagement portion and the pawl cam portion.

14. The mechanism of claim 11, wherein the sperrad engagement portion comprises a tooth and the pawl engagement portion comprises a tip configured to engage and releasably interlock with the tooth.

15. The mechanism of claim 11, wherein the sperrad comprises a hexagonal perimeter and the perimeter comprises the engagement portion.

16. The mechanism of claim 11, further comprising a plurality of pawls, each pawl rotatably mounted on the backing plate and having an engagement portion and a cam portion, each pawl being configured to rotate only between a first arc in which the engagement portion remains at least in part within the engagement zone and a second arc in which the pawl halts the rotation of the sperrad should the pawl be refrained from rotating out of the second arc.

17. The mechanism of claim 16, wherein the plurality of pawls are positioned about the sperrad equidistant from each other.

18. The mechanism of claim 16, wherein the sperrad comprises a plurality of engagement portions configured to engage one or more of the pawl engagement portions.

19. The mechanism of claim 18, wherein the plurality of sperrad engagement portions are positioned equidistant from each other about the sperrad.

20. The mechanism of claim 11, wherein the mechanism comprises a sperrad cam and a sperrad ring, the sperrad cam rotating relative to the pawl, the sperrad ring encircling and rotating about the pawl and sperrad cam, the engagement zone oriented between the pawl and the sperrad ring, the sperrad cam moving the pawl to urge the pawl engagement portion into the engagement zone.
